(19) United States
(12) Patent Application Publication
(10) Pub. No.: US 2014/0005298 A1
(43) Pub. Date: Jan. 2, 2014

(54) COMPOSITION FOR AN INTUMESCENT FIRE PROTECTION COATING, FIRE PROTECTION COATING, ITS USE AND MANUFACTURING PROCESS FOR AN INTUMESCENT FIRE PROTECTION COATING

(71) Applicant: Volker Thewes, Bornsen (DE)

(72) Inventor: Volker Thewes, Bornsen (DE)

(73) Assignee: Rudolf Hensel GmbH, Bornsen (DE)

(21) Appl. No.: 13/695,521

(22) PCT Filed: Mar. 17, 2011
(86) PCT No.: PCT/IB2011/000603

§ 371 Date: Oct. 31, 2012

(51) Int. Cl. C09D 5/18

(52) U.S. Cl. CPC C09D 5/185
USPC 523/179

(57) ABSTRACT

The invention is a composition for an aqueous, intumescent fire protection coating, consisting of at least one silicone resin emulsion and an agent forming foam in case of fire. Furthermore, the invention concerns an intumescent fire protection coating made with such composition, as well as the application and a manufacturing process for this composition.

### SUMMARY

The subject of the invention is a composition for an intumescent fire protection coating, consisting of at least one silicone resin emulsion and an intumescence component. The invention furthermore concerns an intumescent fire protection coating from such a composition, as well as the application and a manufacturing method for this composition.

Intumescent fire protection coatings, also called intumescent coatings (ICs), are characterised by the fact that—in case of fire—they foam under appropriate temperature conditions. Due to this effervescence of the aforementioned fire protection coating, the transmission of heat on steel and aluminium constructions, ceilings, walls, cables, pipes and similar materials is prevented or at least obstructed, On the one hand, such ICs must be applicable on various undergrounds and materials in a fast and simple manner—i.e., in as few processing steps as possible—and allow for short drying times. At the same time, the objective of any fire protection coating is to reach maximum fire resistance periods [FRP] while ensuring minimum application thickness and—in all other respects—resistance against weathering influences, which imposes high demands on the respective fire protection coatings, in particular when it comes to structural elements used outdoors. This also applies for elements which are coated in workshops (off-site application) and which are subsequently stored outdoors, often at least temporally or entirely up to their intended use.

Standard commercial intumescent fire protection coatings for conventional structural elements are usually single-component ICs (1K-IC) on water or solvent basis, The weathering resistance of the aforementioned coatings, in particular of the water-based coatings, is low—frequently requiring the application of an additional cover coating once the coated structural elements are exposed to humidity.

Although the 1K-IC elements manufactured on solvent basis have better weathering resistance values than the water-based systems, they still require top coating when applied outdoors. Due to the high thermal plasticity of these 1K-IC elements, the resulting insulation foams are rather soft and unstable, frequently leading to partial or complete dropping of the insulation foams in case of fire consequently rendering FRP values too low. This effect is in particular detected among hollow parts (rectangular or circular steel beams and supports) as well as with castellated beams and/or supports.

Conventional commercial ICs for industrial structural elements (on- and offshore) are usually two-component ICs (2K-IC) on basis of epoxy resins. The application of the 2K-ICs on basis of epoxy resins is complex and difficult, since the rheological characteristics of these coating systems are poor. For this reason, the aforementioned coating systems are applied using higher temperatures. Due to the chemical cross-linking of the 2K-ICs on epoxy resin basis, these coating systems primarily exhibit thermoset characteristics, which are counter-productive for the development of an expanding insulation layer. After the hardening process, epoxy resins have a high thermal resistance, resulting in poor thermoplastic properties of the coating in case of fire and preventing or impeding the desired intumescence behaviour to develop. Consequently, these fire protection coatings ought to have a very high layer thickness to be able to generate the demanded FRP values.

The task underlying the invention presented here now is to provide a composition for an intumescent fire protection coating which—after its application as fire protection coating—on the one hand exhibits improved weathering resistance and which—on the other hand—meets the fire protection requirements for industrial structural elements as so-called single-component, intumescent fire protection coating (hydrocarbon fire) while improving fire resistance periods (FRP) in cases of thinner layer thickness on different materials and undergrounds at the same time.

This task is solved via a composition for an aqueous intumescent fire protection coating in accordance with claim 1, via a fire protection coating in accordance with claim 12, by applying a composition according to the invention specifications in accordance with claim 13 as well as with a manufacturing process according to claim 14.

A composition in line with invention specifications has at least one silicone resin emulsion as bonding agent and an agent building foam in case of fire. A fire protection coating manufactured on basis of a composition as initially specified, has an improved weathering resistance; due to the excellent hydrophobic characteristics of silicone resin emulsions, a so-called single-component intumescent fire protection coating has an improved fire protection resistance in particular in relation to the conventional single-component. In addition, high expansion values of the insulating foam layers are generated in case of fire at the same time due to the good thermal plasticity of the bonding agents with the silicone resins. The obtained fire resistance periods (FRP) are clearly improved compared to commercially available state-of-the-art systems, allowing to reach a pre-defined FRP with thinner layers.

The invented aqueous intumescent fire protection coating has a water content of at least 2 parts by weight [pbw] related to 100 pbw of total recipe. However, the water content related to 100 pbw % total recipe can also be ≧5 pbw, ≧8 pbw or higher,

The combination of the found characteristics in particular allow the use of the invented composition for a fire protection coating paints in paintable, sprayable or spreadable form for the protection of various undergrounds as well as of conventional and industrial structural elements, preferably made of steel, aluminium, wood, concrete, electrical cables and pipes, or for the coating of open steel profiles, closed and/or castellated profiles, or for workshop applications (off-site application).

In addition, it has surprisingly turned out that the developing insulation layers have excellent mechanical resistance values due to the silicone resin bonding agent component, significantly improving the fire protection performance on—for instance—hollow and castellated profiles. In particular, partial dropping of the insulation layer at the edges of castellated profiles or hollow structures is prevented when using the invented composition or fire protection coating. In the same manner, the typically intensively pronounced cracking of the insulating layer when applied on hollow structures or castellated profiles is prevented by the invented composition.

Due to special mechanical resistance of the insulating layer when manufactured as invented the fire protection coating with a silicone resin bonding agent component also meets the requirements of a hydrocarbon fire in accordance with UL1709 (UL=Underwriters Laboratories).

The invented composition for an intumescent fire protection coating can be manufactured according to invention specifics by a procedure according to which a silicone resin emulsion as bonding agent is mixed in a high-shearing dissolver with an agent which produces foam in case of fire.

The relevant requirements as well as the following descriptions contain particularly favourable aspects and further derivatives of the invention. It is, however, explicitly pointed out that the invented fire protection coating as well as the application of the composition and the manufacturing process for the composition can also be applied according to the respective requirements for the invented composition for an intumescent fire protection coating and vice versa.

The subject of the invention is, among other things, a composition for an intumescent fire protection coating, consisting of at least one silicone resin emulsion and an agent forming foam in case of fire, also called intumescent agent. Such intumescent agents are preferably solid additives, which can also be used in combination with a pigmentation. According to invention specifics, any intumescent agent can be used, as long as it is compatible with the bonding agent; in this case with the applied silicone resin component in particular.

In one form, the intumescent component can consist of an acid-forming substance, i.e., an acid donor, a carbon-producing substance, i.e., a source of carbon, and a propellant, i.e., a gas producer. Preferential samples of such components will subsequently be described in greater detail.

The silicone resin emulsions preferably used in the compositions according to invention specifics contain an organic solvent ratio of less than 25% (weight percentage [pbw] related to 100% dispersion) thus allowing a relatively fast physical drying process on the structure or construction element to be protected after application of the composition. Most of the used solvents have an organic basis and are thus more or less harmful for both the environment and people's health. As alternative to silicone resin emulsions with organic solvents, silicone resin emulsions, exclusively containing water as solvents can be used as well.

The organic solvents are preferably, but non-exclusively:
aromatic hydrocarbons, here xylene and/or alkyl benzene, here preferably ethyl benzene;
alcohols, here methanol and/or alkane oils, particularly preferred 2-methyl-1-propanol-polyether, here preferably polyglycol ether, particularly preferred alpha-iso-tridecyl-omega-hydroxy-polyglycol ether.

The silicone resin emulsions used for the invented intumescent coating are, for example, polysiloxane, silane-siloxane mixtures or preferably, but non-exclusively, modified polysiloxane, dispersions of phenyl and/or methyl-group-modified polysiloxane resins. The invented intumescent coating can also exclusively be manufactured on basis of a silicone resin emulsion as bonding agent. However, a silicone resin emulsion can alternatively be used in combination with additional film-forming, aqueous, organic polymer dispersions. Here, random mixing ratios are possible, as long as the polymer components are compatible with each other.

The preferably used silicone resin emulsions, for example, have a solid content of ≧35 pbw, a density (with T=25° C.) of ≧0.80 g/cm³, a viscosity (with T=25° C.) of ≧10 mPa*s and a flash point of ≧15° C. However, the solid content can be 40-pbw, ≧50 pbw, or higher.

Density (with T=25° C.) can as well be ≧0.85 g/cm³, ≧0.90 g/cm³, or higher. The preferred viscosity values are (with T=25° C.)≧20 mPa*s, ≧30 mPa*s, ≧50 mPa*s or higher. Preferential flash points are ≧20° C., ≧25° C., ≧30° C., ≧40° C., ≧50° C. or higher.

The emulsifying agents applied with the preferred silicone resin emulsions are preferably, but non-exclusively, non-ionic emulsifying agents.

The invented silicone resin emulsions contain a ratio of <15% triethoxy (2.4.4-trimethlypentyl) silane and/or trimethoxy (2.4.4-trimethlypentyl) silane, preferably <5% and a share of <10% tridecanolethoxylate, preferentially <5%.

The preferred phenyl methyl poly-siloxane resins are generally well compatible with organic polymer dispersions. These organic polymer dispersions are preferably, but non-exclusively
homopolymers on vinyl acetate basis,
copolymers on vinyl acetate, ethyl and vinyl chloride basis,
copolymers on basis of vinyl acetate and the vinyl ester of one or several long-chain, branched carbonic acids,
copolymers on vinyl acetate and maleic acid di-n-butyl ester basis
copolymers on vinyl acetate and acrylic acid ester basis,
copolymers on styrene and acrylic acid ester basis,
copolymers on acrylic acid ester basis,
copolymers on vinyl toluene and acrylic acid ester basis,

In addition to the abovementioned silicone resin emulsions, silicone resin systems such as solid silicone resins, silicon oil emulsions, silicone copolymers, silicone concentrates, silicone resin solutions, functional silicone oils and silanes can be used as bonding agents as well, as far as they can be intermixed and diluted with water or are water-soluble.

In a preferred derivative form, the composition for a intumescent fire protection coating contains acid-forming substances. The acid donors are—in principle—salts or esters of inorganic acids. The inorganic acid can—for instance—be boron, sulphur or phosphoric acid. Preferred are ammonium salts of phosphoric acids and/or poly phosphor acids. Particularly preferred as acid-producing substances are ammonium polyphosphates with the formula (NH₄PO₃)ₙ, whereby n is a number between 10 to 1000, preferably between 200 to 1000.

Experts are well aware of examples of carbon-producing substances, whereby the use of carbohydrates, such as pentaerythritol, dipentaerythritol, tripentaerythritol and/or poly-condensation products of pentaerythritols and/or pentaerythritol mixtures which are based on esters and polyols, is particularly preferred. Additional sources of carbon can be groups containing amylum and expanded graphite.

Propellants are gas producers which do not form combustible gases during thermal decomposition. Sample propellants are melamine and/or guanidine as well as their salts and/or urea compounds and/or dicyandiamide, as well as trichloroethylene (hydroxyethyl), isocyanogen urate and its derivatives. The preferred propellant is melamine. Preferred melamine salts are melamine phosphate, melamine cyanurate, melamine borate, melamine polyphosphate, melamine silicate and—in case of the guanidine salt—guanidine phosphate. In addition to the non-halogen gas producers, compounds containing halogen, such as chlorinated paraffins (CPs), can also be used. In addition to the gas-forming characteristics, CPs additionally serve as flame retardants in the gaseous phase, since they interrupt the radical chain reaction of the burn process.

In addition to these foam-forming components further components can be contained in the invented fire protection coating composition as well, allowing for a special adjustment of the coating possible to the respective target application. Non-concludingly enumerated samples of such additional components are, e.g., standard excipient agents and additives, such as pigments—preferably titanium dioxide—glass fibres, mineral fibres, kaolin, talcum, alumina, aluminium hydroxide, magnesium hydroxide, precipitated silica, silicates and/or pulverised celluloses, plasticizers, film-forming aids, thixotropic agents, wetting agents and dispersants and/or preservatives.

The composition for a intumescent fire protection coating in accordance with invention specifics can furthermore contain phosphine acid salt of the formula (I) and/or a di-phosphine acid salt of the formula (II) as additive and/or their polymers,

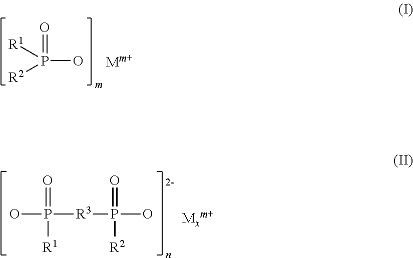

whereby the following applies
R¹, R² are the same or different and C₁-C₆ alkyl are linear, or branched and/or aryl;
R³ C₁-C₁₀ alkyl, linear or branched, C₁-C₆ arylene, alkyl arylene or -arylalkyl;
M Mg, Ca., Al, Sb, Sn, Ge, Ti, Zn, Fe, Zr, Ce, Bi, SR, Mn, Li, Na, K and/or a protonated nitrogen base;
m 1 to 4;
n 1 to 4;
x 1 to 4.

The preferred ‘M’ is calcium, aluminium or zinc.

The protonated nitrogen bases are preferably the protonated bases of ammonia, melamine, tri-ethanol amine, in particular NH₄⁺.

Preferred are R¹, R² identical or different, meaning C₁-C₆ alkyl, linear or branched and/or phenyl. Particularly preferred are R¹, R² identical or different, meaning methyl, ethyl, n-propyl, iso-propyl, n-butyl, tert,-butyl, n-pentyl and/or phenyl.

R³ is preferably methyl, ethyl, n-propylene, iso-propylene, n-butyls, tert.-butyl, n-pentyl, n-octyl or n-dodecyl; phenyl or naphthyl; methyl-phenyl, ethyl-phenyl, tert,-butyl-phenyl, methyl-naphthyl, ethyl-naphthyl or tert.-butyl-naphthyl; phenyl-methyl, phenyl-ethyl, phenyl-propyl or phenyl-butyl.

When using the aforementioned phosphine and/or di-phosphine acid salts, the starting temperature of the intumescent reaction is reduced by more than 15° C. compared to the non-phosphine acid salt recipe.

The invented composition can be used for the production of an intumescent fire protection coating which is improved compared to the conventional single-component coating. Such a fire protection coating is usually created by physically drying a layer of one of the previously described compositions. This is preferentially ensured by evaporating the solvent or a part of the solvent contained in the dispersion resulting in a coherent coating with at least one silicone resin as bonding agent which exhibits the previously described improved characteristics regarding weathering resistance, fire resistance period and the mechanical firmness of the insulating foam layer in relation to the conventional coatings.

The composition for the production of such an intumescent fire protection coating is preferably applied in paintable, sprayable or spreadable form to protect different undergrounds, preferably steel, aluminium, wood, concrete, electrical cables and pipes.

The invented composition for an intumescent fire protection coating is particularly suited for the constructional fire protection of hollow and castellated profiles, as well as for workshop applications and in areas where increased weathering resistance is demanded.

An exemplary recipe for the invented composition for an intumescent fire protection coating is:
1 to 75 pbw of a film-forming bonding agent,
5 to 50 pbw of an acid-forming substance,
5 to 25 pbw of a carbon-producing substance,
5 to 25 pbw of a propellant and
10 to 50 pbw of standard excipients and additives.

Particularly preferred is the following composition content:
5 to 61 pbw of a film-forming bonding agent,
10 to 40 pbw of an acid-producing substance,
7 to 15 pbw of a carbon-producing substance,
7 to 15 pbw of a propellant and
15 to 40 pbw of standard excipients and additives.

These recipes can be used—for instance—in the manufacturing process for a composition for an intumescent fire protection coating according to invention specifics. In the manufacturing process, a silicone resin emulsion can be mixed as a bonding agent with an agent forming foam in case of fire and other optional excipients and additives in a high-shearing dissolver. When mixing the composition in the high-shearing dissolver the agitating speed, dispersion time and the container dimensions should be co-ordinated in such way that the composition's temperature of T=50° C. to T=40° C. is not exceeded during the entire manufacture process.

The invented composition for an intumescent fire protection coating is preferentially produced in the form

that
a) the solvent and the lacquer additives such as dispersing agents, preservatives and anti-foaming agents are inserted while stirring,
b) the solid additives acid donors, propellants and carbon sources as well as the titanium dioxide and fillers are interspersed while stirring at low speed,
c) the thixotropic agent are interspersed subsequently,
d) the mass disperses for at least 15 minutes and a temperature of T=50° C., preferably T=45° C., or rather T=40° C. is not exceeded and subsequently
e) the bonding agent(s) is/are added while stirring and
f) the film-forming aid(s) is/are added if necessary while stirring, and finally
g) the mass disperses homogeneously for at least 5 minutes—at a peripheral speed of the dissolver disk of 18-25 m/s; the desired viscosity is ensured by adding the required solvents.

Should the quantity of solvents added under a) not provide for a sufficient dispersion of the solid additives, the silicone resin emulsions are also characterised by the fact that—due to their high shear stability—they can alternatively also be directly inserted into the receiver.

The preferred dissolver to create the coating according to invention specifics is a disk stirrer, with a vertical shaft and a dissolver disk studded with teeth. The shearing forces developing during the disk's rotation grind the associated solid particles. To ensure sufficient power transmission, the ratio of the dissolver disk and stirrer container, as well as the number of revolutions and filling level must be considered. The process is to be performed in such a way that the fire protection coating is set into a turbulence free rolling motion (doughnut effect) and the dispersed small solid particles are stabilised so that their re-attachment is prevented. The best dispersion results are obtained, if the doughnut effect remains stable while ensuring a high mechanical stirring performance.

The preferred container diameter is 1.3 to 3 times the diameter of the dissolver disk. The filling level of the container should not exceed the diameter of the dissolver disk by more than factor two.

The following examples have the purpose of further explaining the invention. They are to provide specific information to experts at which ratios or combinations the components can be used and how they obtain their advantages concerning certain characteristics. The examples are particularly designed to compare the products according to invention specifics with conventional products when it comes to physical characteristics. In no case, however, are the examples to limit the invention to these special concentrations and combinations.

Among others, the following products were used in the examples below:
Silikophen® P40/W (Evonik Tego Chemie GmbH)

This is an approx. 50% aqueous, non-ionic dispersion of a phenyl-methyl-polysiloxane resin with a solvent ratio of 12% xylene.
Silres® MP 50 E (Wacker Silicones)

This is an approx. 50% aqueous, non-ionic dispersion of a phenyl-methyl-polysiloxane resin with a solvent ratio of 8% xylene.
Silres® SB 45 E (Wacker Silicones)

This is an approx. 50% aqueous, solvent-free silicone resin emulsion, which can be diluted with water.
Epilox® T 19-38/700 (Leung Harze)

This is a modified, low viscous epoxy resin, which is crystallization-free, The preferential temperature for the cross-linking with suitable hardeners is ambient temperature. The equivalent epoxy weight is 180-200 g,
Epilox® Harter M 972 (Leuna Harze)

This is a low-viscous solvent-free, polyaminoamide adduct for solvent-free and low-solvent coating resin systems as well as coatings. The amine equivalent weight is 115 g.
Mowilith® DM230 (Celanese Emulsions GmbH)

This is an approx. 50%, plasticizer-free, aqueous copolymer dispersion made of vinyl acetate and versatic acid ester.
VINNAPAS® EZ 3010 (Wacker Chemie AG)

This is an approx. 55%, plasticizer- and solvent-free, aqueous polymer dispersion, made of the monomers vinyl acetate and ethyl.
Exolit® AP 462 (Clariant GmbH, Frankfurt/Main)

This is a micro-capsulated ammonium polyphosphate on Exolit® AP 422 basis, which was manufactured according to the EP-B-0 160 795 method and which contains about 10 mass % capsule material, consisting of a hardened melamine and/or formaldehyde resin.
Exolit® AP 422 (Clariant GmbH, Frankfurt/Main)

This is a free-flowing, powdered ammonium polyphosphate of the formula (NH4PO3) with n=20 to 1000, in particular 500 to 1000, which is slowly soluble in water. The ratio of particles with a particle size smaller than 45 μm is over 99%.

### Exolit® OP 1230 (Clariant GmbH, Frankfurt/Main)

Exolit® OP 1230 is a fine-grained, non-hygroscopic powder on basis of an organic phosphinate which is non-soluble in water and usual organic solvents.
Charmor® PM 40

This is a crystalline, free-flowing, powdered penta-erythrit of the formula (C₅H₁₂O₄).

### General Information:

In the following, sample compositions for intumescent coatings were manufactured, applied on standard steel plates as well as on hollow and castellated profiles and their effectiveness was determined according to the following standards.

The insulating quality was examined according to IS0834 and UL1709.

Weathering resistance was examined by means of a six-month exposure to outdoor weather conditions (site: 21039 Börnsen-Germany). After evaluation of the surface, the steel plates were submitted to a fire test in line with IS0834. This weathering resistance test was accomplished with a dry film thickness of 1000 μm.

### EXAMPLE 1

### (Comparative Example IS0834):

The following substances were mixed successively using a high-shearing dissolver and were subsequently applied on the appropriate test items via airless application technique.
25 pbw Exolit® AP462
20 pbw Mowilith® DM230
8 pbw melamine
8 pbw Charmor PM 40
8 pbw titanium dioxide
ad 100 pbw water, fillers and excipients.

The recipe was implemented in the form that the solids were stirred into the liquid receiver at low speed and the fire protection coating was subsequently fully dispersed at a peripheral dissolver disk speed of 18-25 m/s. It was ensured that a stable doughnut effect formed during the dispersion process and that the temperature in the coating T=40° C. was not exceeded.

In the examples, the fire protection coating was applied with an airless pump with the following configuration at ambient temperature (T=20° C.). These framework conditions are appropriate conditions for an application according to invention specifics:
Material pressure, approx. 200 bar
Mechanical handling capacity >4 l/min
Hose diameter ⅜ inch-length <20 m
Whip hose ½ inch
Spraying nozzle between 0.017-0.025 inches
Filters were left in the airless pump and the spray gun

Up to a quantity of 1000 g/m², the coating was applied wet and in one processing step. When using several application cycles, a drying time of at least 24 hours between processing steps was maintained.

Before the coating was applied on the steel surfaces, a pre-treatment was accomplished via ultra-high pressure abrasive blasting (SA ½) according to DIN EN ISO 12944-4 and a priming of approx. 40-60 μm dry layer thickness was applied, followed by a drying time of 24 hours.

The fire test of a steel plate (495×495×5 mm) similar to IS0834 showed a fire resistance time of 67 minutes (T_{critical}=500° C.), The start of the intumescent reaction was registered at T=225° C. (measured on the back of the disk). The resistance of the resulting foam structure was low and not cut resistant. The same recipe had a remaining fire resistance period of only 51 minutes after a 6-month period of outdoor weathering. These fire tests were accomplished with a dry film thickness of 1000 μm.

The same recipe, applied with a dry layer thickness of 2000 μm on a circular support (profile factor U/A=165 m⁻¹), did not have a satisfying fire protection performance, since the expanding and insulating foam layer cracked at the perforation edges and exposed the steel surface thus significantly reducing the FRP.

The same recipe, applied with a dry layer thickness of 1500 μm on a castellated profile (profile factor U/A=152 m⁻¹), neither led to a satisfying fire protection performance, since the expanding and insulating foam layer cracked at the perforation edges and exposed the steel surface.

### EXAMPLE 2

### (Comparative Example UL1709):

A two-component fire protection coating based on epoxy resins was manufactured with the following components using a high-shearing dissolver under comparable conditions as outlined in example 1 with the exception that higher temperatures of T=approx. 60° C. were applied and that no solvents were used.

### Component A:

35 pbw bisphenol A/F resin
8 pbw phosphoric acid esters
30 pbw boric acid
8 pbw Exolit AP422
6 pbw Charmor PM 40
ad 100 pbw of fillers and excipients

### Component B:

55 pbw of polyamine hardener
4 pbw titanium dioxide
5 pbw Exolit AP422
3 pbw Charmor PM 40
ad 100 pbw of fillers and excipients

The A and B components were mixed according to their epoxy and/or amine equivalence and applied on a steel plate with a blade and a dry layer thickness of 5 mm. The fire test of a steel plate (495×495×5 mm) similar to UL1709 resulted in a fire resistance period of 60-minutes, No reduction of the fire resistance period was determined after an outdoor weathering period of 6 months.

### EXAMPLE 3

### (Invention):

The following substances were successively mixed using a high-shearing dissolver as outlined in example 1 and subsequently applied on the appropriate test items using an airless application technique under the same conditions as described in example 1.
35 pbw Exolit AP422
12 pbw Silres MP 50 E
11 pbw Charmor PM 40
10 pbw melamine
10 pbw titanium dioxide
ad 100 pbw, fillers and excipients.

This recipe is characterised by the fact that its production does not require additional water and that the powder can directly disperse in the bonding agent allowing for a significant increase of the solid content per volume and/or weight compared to the conventional 1-component fire protection coatings on aqueous or solvent basis.

The fire test of a steel plate (495×495×5 mm) in line with IS0834 showed a fire resistance period of 82 minutes (I_{critical}=500° C.). The resulting foam structure was highly stable and cut resistant. The same recipe had a remaining fire resistance period of 65 minutes after a six month outdoor weathering exposure. These fire tests were accomplished with a dry film thickness of 1000 μm.

Compared to the reference (example 1) the efficiency was improved by 22% (zero-sample) and 27% (after weathering).

The same recipe, applied with a dry layer thickness of 2000 μm on a circular support (profile factor U/A=160m⁻¹), led to a 30-minute fire protection performance, since the expanding insulating foam layer did not crack.

### EXAMPLE 4

### (Invention):

The following substances were mixed successively with a high-shearing dissolver and subsequently applied via an airless application technique on the appropriate test items. Here, the same conditions were applied as in example 1.
24 pbw Exolit AP422
2 pbw Exolit OP1230
13 pbw Vinnapas EZ 3010
13 pbw Silikophen P40NV
8 pbw Charmor PM40
6 pbw melamine
10 pbw titanium dioxide ad 100 pbw water, fillers and excipients.

The fire test of a steel plate (495×495×5 mm) in line with IS0834 showed a fire resistance period of 85 minutes (I_{critical}=500° C.). The start of the intumescent reaction was registered with T=183° C. (measured on the back of the disk), which corresponds to a reduction of T=42° C. compared to the reference (example 1). The resulting foam structure was highly stable and cut resistant. The same recipe had a remaining fire resistance period of 82 minutes after an outdoor weathering exposure of six month. These fire tests were carried out with a dry film thickness of 1000 μm, Compared to the reference (example 1), the efficiency was improved by 27% (zero-sample) and 61% (after weathering).

The same recipe applied on a castellated profile (U/A=152) with a dry layer thickness of 1500 μm led to a 60-minute fire protection performance, since the expanding insulating foam layer did not crack at the perforation edges.

### EXAMPLE 5

### (Invention):

The following substances were successively mixed using a high-shearing dissolver and subsequently applied on the appropriate test items using an airless application technique as described in example 1.
35 pbw Exolit AP462
26 pbw Silres MP 50 E
11 pbw Charmor PM 40
9 pbw melamine
13 pbw titanium dioxide
ad 100 pbw of fillers and excipients.

This recipe is characterised by the fact that its production does not require additional water and that the powder can directly disperse in the bonding agent allowing for a significant increase of the solid content per volume and/or weight compared to the conventional 1-component fire protection coatings on aqueous or solvent basis,

The fire test of a steel plate (495×495×5 mm) in line with IS0834 showed a fire resistance period of 79 minutes (I_{critical}=500° C.), The resulting foam structure was highly stable and cut resistant. The same recipe had a remaining fire resistance period of 66 minutes after a six-month outdoor weathering exposure. These fire tests were carried out with a dry film thickness of 1000 μm. Compared to the reference (example 1), the efficiency was improved by 18% (zero-sample) and 29% (after weathering),

The fire test of a steel plate (495×495×5 mm) in line with UL1709 showed a fire resistance period of 60 minutes. No reduction of the fire resistance period was determined after an outdoor weathering period of 6 months. These fire tests were carried out with a dry film thickness of 4.2 mm. Compared to the reference (example 2), the efficiency was improved by 16%.

### EXAMPLE 6

### (Invention):

The following substances were successively mixed using a high-shearing dissolver and subsequently applied on the appropriate test items using an airless application technique as described in example 1.
25 pbw Exolit AP422
16 pbw Vinnapas EZ 3010
10 pbw Silres MP 50 E
8 pbw Charmor PM40
8 pbw melamine
8 pbw titanium dioxide
ad 100 pbw water, fillers and excipients.

The fire test of a steel plate (495×495×5 mm) in line with 130834 showed a fire resistance period of 82 minutes (T_{critical}=500° C.). The resulting foam structure was highly stable and particularly cut resistant. The same recipe had a remaining fire resistance period of 79 minutes after a six month outdoor weathering exposure. These fire tests were carried out with a dry film thickness of 1000 μm. Compared to the reference (example 1), the efficiency was improved by 22% (zero-sample) and 55% (after weathering).

The same recipe applied on a castellated profile (U/A=160^{m-1}) with a dry layer thickness of 2000 μm led to a 30-minute fire protection performance, since the expanding insulating foam layer did not crack at the perforation edges.

The same recipe, applied with a dry layer thickness of 1500 μm on a castellated profile (U/A=152^{m-1}), led to a 60-minute fire protection performance, since the expanding insulating foam layer did not crack at the perforation edges.

### EXAMPLE 7

### (Invention)

The following substances were mixed successively using a high-shearing dissolver and subsequently applied via airless application on the corresponding test items. Here, the same conditions were applied as in example 1.
25 pbw Exolit AP462
20 pbw Vinnapas EZ 3010
6 pbw Silres SB45
8 pbw Charmor PM40
8 pbw melamine
8 pbw titanium dioxide
ad 100 pbw water, fillers and excipients.

This recipe is characterised by the fact that it does not contain any organic solvents.

The fire test of a steel plate (495×495×5 mm) in line with IS0834 showed a fire resistance period of 86 minutes (T_{critIcal}=500° C.). The resulting foam structure was highly stable and particularly cut resistant. The same recipe had a remaining fire resistance period of 86 minutes after a six month outdoor weathering exposure. These fire tests were carried out with a dry film thickness of 1000 μm. Compared to the reference (example 1), the efficiency was improved by 28% (zero-sample) and 69% (after weathering).

The same recipe applied on a castellated profile (U/A=160^{m-1}) with a dry layer thickness of 2000 μm led to a 33-minute fire protection performance, since the expanding insulating foam layer did not crack at the perforation edges.

The same recipe, applied with a dry layer thickness of 1500 μm on a castellated profile (U/A=152 m−1), led to a 60-minute fire protection performance, since the expanding insulating foam layer did not crack at the perforation edges.

In summary, it is to be pointed out once again that the preceding detailed compositions and coatings are only preferential samples that can be modified as required by experts in various ways while maintaining the invention's application area. Other concentrations of the respective components can be used specifically, as long as the compounds have a sufficient fire protection suitability. The compositions according to invention specifics can preferentially be used as intumescent fire protection coatings, for example, to prevent the transmission of heat on steel and aluminium constructions, ceilings, walls, cables, pipes and the like in case of fire. The examples clearly show that the compositions according to invention specifics, lead to an improved weathering resistance on the one hand, and, on the other meet the fire protection requirements for industrial structural elements (hydrocarbon fire) as so-called single-component, intumescent fire protection coatings after application as fire protection coatings while providing improved fire resistance periods (FRP) on various materials and undergrounds with layers of limited thickness.

It was furthermore possible to demonstrate, among other things, that the compositions according to invention specifics significantly improve the fire protection performance on—for example—hollow and castellated profiles. In particular, the partial dropping of the insulation layer at the edges of a castellated profile or a hollow structure is prevented when using the invented composition or fire protection coating. The typically occurring distinct crack formation in the insulating layer is prevented as well, when using hollow structures or castellated profiles with the invented composition.

Due to the special mechanical resistance of the insulating layer made of a composition according to invention specifics, the fire protection coating with a silicone resin bonding agent component also meets the requirements of a hydrocarbon fire in line with UL1709 (UL=Underwriters Laboratories). This could clearly be demonstrated with the previous examples, whereby identical or similar fire protection performances are also reached for other concentrations and combinations of ingredients, as long as at least one silicone resin emulsion is contained as bonding agent.

What is claimed is:

1. A composition for an aqueous intumescent fire protection coating, containing at least one silicone resin emulsion as bonding agent, as well as an agent producing foam in case of fire.

2. The composition for an intumescent fire protection coating of claim 1, whereby the composition contains solid additives as foam-producing agents.

3. The composition for an intumescent fire protection coating of claim 1, whereby the silicone resin emulsion is of aqueous nature and contains an organic solvent ratio—preferably aromatic hydrocarbons, alcohols and/or poylether—of 0-25%.

4. The composition for an intumescent fire protection coating of claim 1, whereby the silicone resin emulsion consists of polysiloxane, silane-siloxane mixtures and/or modified polysiloxane,

5. The composition for an intumescent fire protection coating claim 1, whereby the bonding agent—in addition to the silicone resin emulsion—is an aqueous organic polymer dispersion at random mixing ratio and the organic polymer dispersion is a dispersion of one or several of the following polymer components:
homopolymerisate on vinyl acetate basis,
copolymers on vinyl acetate, ethyl and vinyl chloride basis,
copolymers on basis of vinyl acetate and vinyl ester of a long chain,
branched carbonic acid,
copolymers on vinyl acetate and maleic acid di-n-butyl ester basis,
copolymers on vinyl acetate and acrylic acid ester basis,
copolymers on styrene and acrylic acid ester basis,
copolymers on acrylic acid ester basis,
copolymers on vinyl toluol and acrylic acid ester basis,

6. The composition for an intumescent fire protection coating claim 1, characterised by the fact that it contains
1 to 75 pbw of a film-forming bonding agent according to claims 3-5,
5 to 50 pbw of an acid-producing substance,
5 to 25 pbw of a carbon-producing substance,
5 to 25 pbw of a propellant, and
10 to 50 pbw of standard excipients and additives.

7. The composition for an intumescent fire protection coating claim 1, containing an acid-producing substance selected from ammonium salts of phosphoric acids and/or poly-phosphoric acids or ammonium polyphosphates of the formula (NH4PO3)n, whereby n is a number from 10 to ≧1000.

8. The composition for an intumescent fire protection coating claim 1, containing a carbon-producing substance, selected from carbohydrates, in particular pentaerythritol, dipentaerythritol, tripentaerythritol and/or poly-condensation products of pentaerythritol; amylum and expanded graphite.

9. The composition for an intumescent fire protection coating claim 1, containing a propellant, selected from melamine and/or guanidine as well as their salts and/or dicyandiamide, as well as trichloroethylene (hydroxyethyl), isocyanogen urate and its derivatives, and where optionally melamine phosphate, melamine cyanurate, melamine borate, melamine polyphosphate, melamine silicate are used as melamine salts and guanidine phosphates are used as guanidine salts.

10. The composition for an intumescent fire protection coating claim 1, additionally containing one or more expedients and additives, selected from pigments, such as—among others—glass fibres, mineral fibres, kaolin, talcum powder, alumina, aluminium hydroxide, magnesium hydroxide, precipitation silicic acids, silicates and/or pulverised celluloses, phosphine acid salts and/or diphosphine acid salts and/or their polymers, plasticizers, film-forming aids, thixotropic agents, wetting agents and dispersants as well as preservatives.

11. A fire protection coating, manufactured by physically drying a composition layer in line with claim 1, in particular by evaporating the contained solvent, or parts thereof, whereby the fire protection coating contains at least one silicone resin bonding agent.

12. Application of the composition for a fire protection coating claim 1 in paintable, spreadable or sprayable form for the protection of various undergrounds as well as of conventional and industrial structural elements, preferably made of steel, aluminium, wood, concrete, electrical cables and pipes, or for the coating of open steel profiles, closed and/or castellated profiles, or for workshop applications.

13. A manufacturing process for the composition for an intumescent fire protection coating claim 1, characterised by the fact that a silicone resin emulsion is mixed as a bonding agent in a high-shearing dissolver with an agent forming foam in case of fire.

14. The manufacturing process for a composition for an intumescent fire protection coating of claim 13, characterised by the fact that it is dispersed in a high shearing dissolver while ensuring that the composition temperature of T=50° C. to T=40° C. is not exceeded during the entire manufacture process.
